(19) United States
(12) Patent Application Publication
(10) Pub. No.: US 2005/0032956 A1
(43) Pub. Date: Feb. 10, 2005

(54) Coating composition for reinforcing concrete and concrete structure reinforced by same

(75) Inventor: Kunishige Miyoshi, Chuo-ku (JP)

Correspondence Address: OLIFF & BERRIDGE, PLC, P.O. BOX 19928, ALEXANDRIA, VA, 22320, US

(73) Assignee: FIBER KAKEN CO., LTD., Sakado-shi (JP)

(21) Appl. No.: 10/634,882

(22) Filed: Aug. 6, 2003

(51) Int. Cl. C08K 3/04; C08K 3/38; C08K 3/40

(52) U.S. Cl. 524/404; 524/495; 524/494

(57) ABSTRACT

There is provided a paste coating composition for reinforcing concrete comprising: (A) an epoxy resin, (B) a first fiber composed of a ceramic fiber, (C) a second fiber selected from the group consisting of a carbon fiber, an aramid (aromatic polyamide) fiber, a polyketone fiber and a glass fiber and (D) a pigment; and a concrete structure reinforced by the composition. The composition can rapidly form a coat as thick as 0.8 to 1.5 mm on a concrete structure without dropping of the composition. Consequently, the composition can considerably reduce time of works compared With conventional constructions for reinforcing concrete. Further, the concrete structures reinforced by the composition are not only improved in strength but also excellent in weathering performance, resistance to chemicals and decorating performance.

### TECHNICAL FIELD

The present invention relates to a paste coating composition for reinforcing concrete and a concrete structure reinforced by the same.

### BACKGROUND ART

Conventionally, it has been known well to coat a concrete structure with a coating composition for concrete in order to decorate the concrete structure, make it waterproof or prevent neutralization thereof. Such a coating composition for concrete has a coat thickness of only at most 0.15 mm even when it is applied twice or three times. This results from mainly the purpose of the coating composition although this results from efficiency in application.

The conventional methods for reinforcing concrete structures include a method of bonding a carbon fiber sheet or a glass fiber sheet to the structures. However, the method requires many hands and a considerably long time of works.

### DISCLOSURE OF INVENTION

An object of the present invention is to provide a novel paste coating composition for reinforcing concrete that changes a conception on the prior coating compositions for concrete, and can be easily applied for concrete structures thereby imparting a remarkable improvement in strength to the structures; and a concrete structure reinforced by the coating composition.

That is, the present invention relates to a paste coating composition for reinforcing concrete comprising: (A) an epoxy resin; (B) a first fiber composed of a ceramic fiber, (C) a second fiber selected from the group consisting of a carbon fiber, an aramid (aromatic polyamide) fiber, a polyketone fiber and a glass fiber; and (D) a pigment.

The present invention also relates to the paste coating composition for reinforcing concrete, wherein the composition has a viscosity of 10,000 cps to 35,000 cps, preferably 15,000 cps to 30,000 cps and more preferably 20,000 cps to 25,000 cps.

In addition, the present invention relates to the paste coating composition, wherein the composition comprises (A) an epoxy resin; (B) a first fiber composed of a ceramic fiber in an amount of 2 to 5% by weight, preferably 3.5 to 4.5% by weight; (C-1) a carbon fiber in an amount of 1 to 10% by weight, preferably 3.5 to 4.5% by weight; and (D) a pigment in a necessary amount, preferably 1 to 2% by weight in which the amounts are based on a weight of component (A).

Also, the present invention relates to the paste coating composition, wherein the composition comprises (A) an epoxy resin; (B) a first fiber composed of a ceramic fiber in an amount of 1.2 to 5% by weight, preferably 3.5 to 4.5% by weight; (C-2) an aramid fiber or (C-3) a polyketone fiber in an amount of 1 to 7% by weight, preferably 4 to 6% by weight; and (D) a pigment in a necessary amount, preferably 1 to 2% by weight in which the amounts are based on a weight of component (A).

The present invention relates further to the paste coating composition, wherein the composition comprises (A) an epoxy resin; (B) a first fiber composed of a ceramic fiber in an amount of 1.2 to 5% by weight, preferably 3.5 to 4.5% by weight; (C4) a glass fiber in an amount of 2 to 10% by weight, preferably 6 to 9% by weight; and (D) a pigment in a necessary amount, preferably 1 to 2% by weight in which the amounts are based on a weight of component (A).

Further, the present invention relates to a concrete structure, in which any one of the above-mentioned paste coating compositions for reinforcing concrete is applied to a surface of the concrete structure in a coat thickness (dried coat thickness) of 0.8 to 1.5 mm.

The first or second fiber used in the present invention has a length of 0.5 to 10 mm, preferably 1 to 6 mm, more preferably 1 to 4 mm. If the fibers have a length less than 0.5 mm, they cannot fully play a roll as reinforcing fibers, while if they have a length more than 10 mm, they deteriorate application properties of the coating composition and therefore are not preferable. The optimum length of the fibers depends on the material of respective fibers. Ceramic fibers as a first fiber have a length of 5 to 10 mm, preferably 3 to 6 mm, and as a second fiber, carbon fibers have a length of 1 to 6 mm, preferably 3 to 5 mm, aramid fibers or polyketone fibers have a length of 1 to 6 mm, preferably 3 to 5 mm, and glass fibers have a length of 0.5 to 5 mm, preferably 1 to 3 mm.

The optimum size (diameter) of the fibers also depends on the material of the respective fibers. Ceramic fibers as a first fiber have a diameter of 150 to 600 μm, preferably 200 to 300 μm, and as a second fiber, carbon fibers have a diameter of 3 to 15 μm, preferably 5 to 10 μm, aramid fibers or polyketone fibers have a diameter of 5 to 20 μm, preferably 7 to 15 μm, and glass fibers have a diameter of 6 to 10 μm, preferably 7 to 9 μm.

Ceramic fibers used in the present invention include, for example alumina fibers, boron fibers, silicon carbide fibers and so on.

Carbon fibers used in the present invention include several types, such as high-strength type, ultra-high-strength type, high-elasticity modulus type and so on, and can be used alone or in a mixture comprising two or more carbon fibers, depending on the purpose.

Aramid fibers used in the present invention include, for example high-elasticity type, ultra-high-elasticity type and so on, and can be used alone or in a mixture comprising two or more carbon fibers, depending on the purpose. In addition, polyketone fibers have a molecular structure in which carbon monoxide is incorporated into the molecular of ethylene, and they are fibers extremely close to aramid fibers in strength, elongation, elasticity modulus, heat shrinkage or specific gravity according to the data from Asahi Kasei Corporation.

Glass fibers or ceramic fibers used in the present invention are preferably subjected to a coupling treatment in order to improve an affinity for resin component.

Epoxy resins used in the present invention are preferably ones for epoxy coatings of cold-drying type. These epoxy coatings may contain a curing agent, such as amines or amine adducts, polyamides (e.g., triethylene tetramine/dimer acid modified polyamides or the like), isocyanates and so on. The epoxy resins can be used as a solvent-free type by using liquid epoxy resins. They include, for example epoxy resins of bisphenol A-type, bisphenol E-type, bisphenol F-type or the like.

The paste coating compositions for reinforcing concrete may include iron powders, preferably iron oxide powders in an amount of 1 to 10% by weight. The iron powders can further improve strength of the concrete structures reinforced with the paste coating composition for reinforcing concrete.

Further, the paste coating compositions for reinforcing concrete according to the present invention may contain several additives that are usually added to coatings for concrete.

The coating composition for reinforcing concrete according to the present invention can rapidly form a coat as thick as 0.8 to. 1.5 mm on a concrete structure without dropping of the coating composition. Consequently, the coating composition can considerably reduce time of works compared with conventional constructions for reinforcing concrete. Further, the concrete structures reinforced by the coating composition are not only improved in strength but also excellent in weathering performance, resistance to chemicals and decorating performance.

### EXAMPLES

In the followings, the present invention is described based on examples to which the present invention is not limited.

### Example 1

The following components: 1000 g of an epoxy resin (bisphenol F liquid epoxy resin), 40 g of a ceramic fiber (length of the fiber: 2 mm), 30 g of a carbon fiber (length of the fiber 3 mm) and 10 g of a pigment were fully kneaded to obtain a mixture. 250 g of modified alicyclic polyamine was added to the mixture prior to use to produce a coating composition. Then, the coating composition was applied to the surface of a concrete plate with thickness of 60 mm in a coating weight of 1.0 kg/m².

Next, flexural strength and compression strength were measured for concrete plates before any coating composition was applied, after the coating composition of Example 1 was applied thereon, and after a commercially available coating composition was applied thereon (Comparative Example). In the interim, each strength after application was measured 7 days after respective coating compositions were applied. The results are summarized in Table 1 described below.

TABLE 1

| | | | Comparative |
|---|---|---|---|
| | Before Application | Example 1 | Example* |
| Flexural | 50 kgf/cm² | 140 kgf/cm² | 60 kgf/cm² |
| Strength | | | |
| Compression | 240 kgf/cm² | 530 kgf/cm² | 250 kgf/cm² |
| Strength | | | |

*The coating composition was applied only in a coating weight of 0.5 kg/cm²

It is clear from the results in Table 1 that the concrete plate on which the coating composition according to the present invention was applied has about three times higher flexural strength and about two times higher compression strength than the concrete plate on which no coating composition was applied. Thus, the coating composition according to the present invention exerts remarkable effects in improvement of flexural or compression strength.

### Example 2

The procedure of Example 1 was repeated except that 50 g of an aramid fiber was used instead of 30 g of an carbon fiber. Consequently, the resulting concrete plate has about three times higher flexural strength and about two times higher compression strength than the concrete plate on which no coating composition was applied, similarly to Example 1. Thus, the coating composition according to the present invention exerts remarkable effects in improvement of flexural or compression strength.

### Example 3

The procedure of Example 1 was repeated except that 80 g of a glass fiber was used instead of 30 g of an carbon fiber. Consequently the resulting concrete plate has about three times higher flexural strength and about two times higher compression strength than the concrete plate on which no coating composition was applied, similarly to Example 1. Thus, the coating composition according to the present invention exerts remarkable effects in improvement of flexural or compression strength.

1. A paste coating composition for reinforcing concrete comprising:
(A) an epoxy resin,
(B) a first fiber composed of a ceramic fiber,
(C) a second fiber selected from the group consisting of a carbon fiber, an aramid (aromatic polyamide) fiber, a polyketone fiber and a glass fiber; and
(D) a pigment.

2. A paste coating composition for reinforcing concrete according to claim 1, wherein the composition has a viscosity of 10,000 cps to 35,000 cps.

3. A paste coating composition for reinforcing concrete according to claim 1, wherein the composition comprises (A) an epoxy resin, (B) a first fiber composed of a ceramic fiber, (C-1) a carbon fiber and (D) a pigment, in which contents of components (B) and (C-1) are 2 to 5% by weight and 1 to 10% by weight based on a weight of component (A), respectively.

4. A paste coating composition for reinforcing concrete according to claim 1, wherein the composition comprises (A) an epoxy resin, (B) a first fiber composed of a ceramic fiber, (C-2) an aramid fiber or (C-3) a polyketone fiber and (D) a pigment, in which contents of components (B) and (C-2) or (C-3) are 1.2 to 5% by weight and 1 to 7% by weight based on a weight of component (A), respectively.

5. A paste coating composition for reinforcing concrete according to claim 1, wherein the composition comprises (A) an epoxy resin, (B) a first fiber composed of a ceramic fiber, (C-4) a glass fiber and (D) a pigment, in which contents of components (B) and (C4) are 1.2 to 5% by weight and 2 to 10% by weight based on a weight of component (A), respectively.

6. A concrete structure, in which the paste coating composition for reinforcing concrete according to claim 1 is applied to a surface of the concrete structure in a coat thickness (dried coat thickness) of 0.8 to 1.5 mm.
